(19) United States
(12) Patent Application Publication
(10) Pub. No.: US 2014/0198112 A1
(43) Pub. Date: Jul. 17, 2014

(54) METHOD OF CONTROLLING INFORMATION PROCESSING APPARATUS AND INFORMATION PROCESSING APPARATUS

(71) Applicant: FUJITSU LIMITED, Kawasaki-shi (JP)

(72) Inventors: Ryo MIYAMOTO, Kawasaki (JP); Kenichi HORIO, Yokohama (JP); Kazuki MATSUI, Kawasaki (JP)

(73) Assignee: FUJITSU LIMITED, Kawasaki-shi (JP)

(21) Appl. No.: 14/097,643

(22) Filed: Dec. 5, 2013

(30) Foreign Application Priority Data
Jan. 11, 2013 (JP) 2013-003565

(51) Int. Cl. G06T 1/20

(52) U.S. Cl. CPC G06T 1/20
USPC 345/522

(57) ABSTRACT

A method of controlling an information processing apparatus includes generating, using a hardware, first image data corresponding to a first area of an image to be displayed on a screen of a client apparatus coupled to the information processing apparatus, generating, using a processor other than the hardware, second image data corresponding to a second area of the image, and transferring the first image data and second image data to the client apparatus separately.

### CROSS-REFERENCE TO RELATED APPLICATION

This application is based upon and claims the benefit of priority of the prior Japanese Patent Application No. 2013-003565 filed on Jan. 11, 2013, the entire contents of which are incorporated herein by reference.

### FIELD

The embodiments discussed herein are related to a method of controlling an information processing apparatus and an information processing apparatus.

### BACKGROUND

Systems, such as a thin-client system in which a server apparatus executes generation of a desktop screen and supplies the generated desktop screen to a client apparatus, have been proposed (see, for example, Japanese Laid-open Patent Publication No. 2007-311957, Japanese Laid-open Patent Publication No. 2011-53769, and Japanese Laid-open Patent Publication No. 2009-187379).

For generating a desktop screen, there is a case in which the server apparatus uses predetermined hardware (for example, a graphics processing unit (GPU) is used to execute rendering of a screen (such a case will be described in conjunction with an example using a GPU), as well as a case in which the server apparatus does not use a GPU to execute rendering of a screen. Image data resulting from execution of the rendering is transferred from the server apparatus to a client apparatus and is used as a desktop screen on the client apparatus.

### SUMMARY

According to an aspect of the invention, a method of controlling an information processing apparatus includes generating, using a hardware, first image data corresponding to a first area of an image to be displayed on a screen of a client apparatus coupled to the information processing apparatus, generating, using a processor other than the hardware, second image data corresponding to a second area of the image, and transferring the first image data and second image data to the client apparatus separately.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a system according to first to third embodiments;

FIG. 2 illustrates an example of using a GPU;

FIG. 3 is a functional block diagram of a server apparatus according to the first embodiment;

FIG. 4 is a flowchart illustrating an operation of a thin-client server according to the first embodiment;

FIG. 5 is a flowchart illustrating an operation of a GPU sharing mechanism according to the first to third embodiments;

FIG. 6 is a flowchart illustrating an operation of a thin-client client according to the first to third embodiments;

FIG. 7 illustrates an operation of image transfer according to the first embodiment;

FIG. 8 is a screen example when two screens have an overlap area;

FIG. 9 is a functional configuration diagram of a server apparatus according to the second embodiment;

FIG. 10 is a flowchart illustrating an operation of a thin client server according to the second embodiment;

FIG. 11 illustrates an operation of image transfer according to the second embodiment;

FIG. 12 illustrates an operation of the image transfer according to the second embodiment;

FIG. 13 is a functional configuration diagram of a server apparatus according to the third embodiment;

FIG. 14 is a flowchart illustrating an operation of a thin-client server according to the third embodiment;

FIG. 15 illustrates an operation of image transfer according to the third embodiment; and

FIG. 16 illustrates an example of the hardware configuration of the server apparatus according to the first to third embodiments.

### DESCRIPTION OF EMBODIMENTS

In the above-described system, the server apparatus combines the image data that is a result of rendering executed by the GPU and image data that is a result of rendering executed without using a GPU and transfers the combined image data to the client apparatus. Thus, for example, when the number of client apparatuses increases, there is a problem in that the load on processing in the server apparatus during transfer of a screen to the client apparatus increases.

Embodiments of the present disclosure will be described below with reference to the accompanying renderings. Herein and in the accompanying renderings, elements having substantially the same functional configuration are denoted by the same reference numerals, and redundant descriptions are not given.

### Example of System Configuration

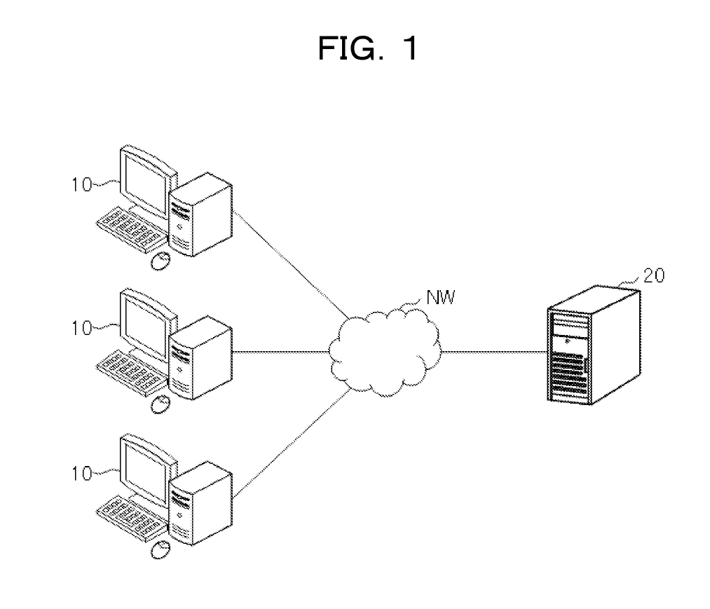

First, a brief description will be given of a configuration example of a system according to first to third embodiments. FIG. 1 illustrates a configuration example of a system according to the first to third embodiments described hereafter. The system according to each embodiment includes three client apparatuses 10 and a server apparatus 20, which are connected to each other through a network NW. The number of client apparatuses 10 is not limited to three and may be one or more.

In this system, the server apparatus 20 executes generation of a desktop screen and supplies the generated desktop screen to the corresponding client apparatus 10. The server apparatus 20 executes rendering to obtain image data and transfers the image data to the corresponding client apparatus 10, and the image data is used as a desktop screen on the client apparatus 10.

The system may be applied to, for example, a virtual desktop system. In a virtual desktop system, a desktop environment constructed in a physical PC (personal computer) is constructed as a virtual desktop environment on a virtual machine (hereinafter referred to as a “virtual machine (VM)”) on the virtualized server apparatus 20. The client apparatuses 10 and so on use the virtual desktop environment through the network NW.

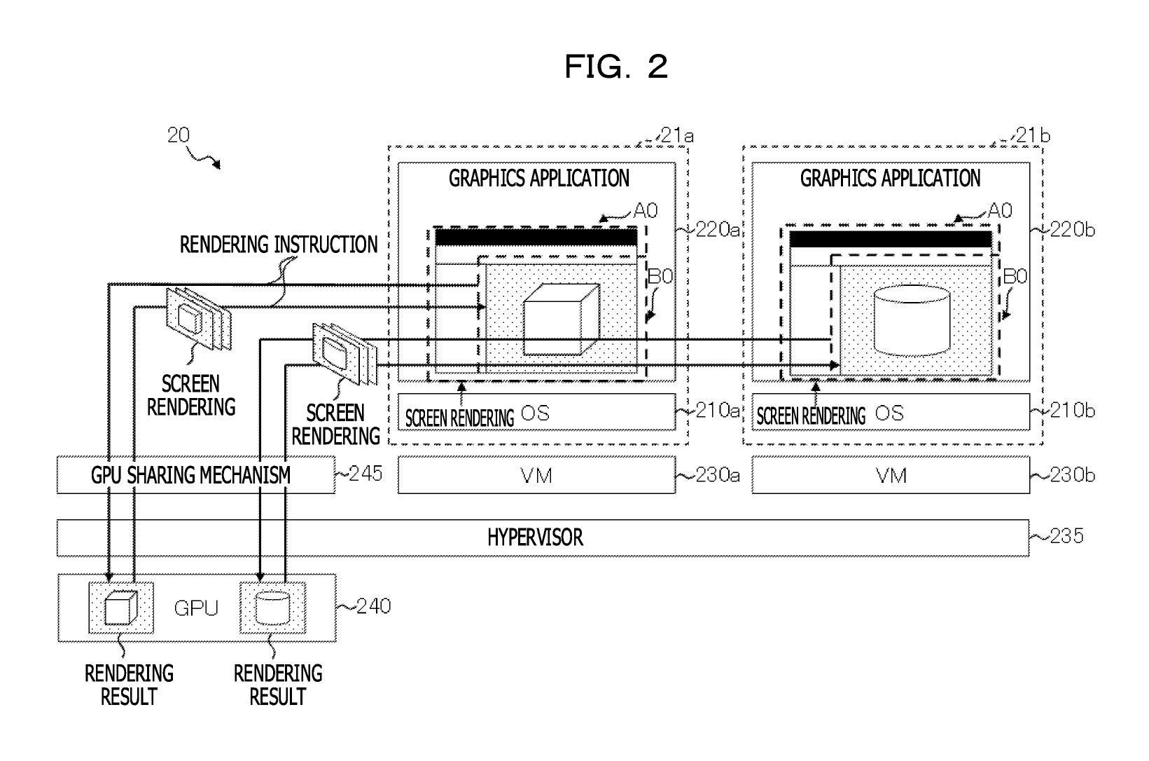

A basic configuration of the server apparatus 20 in the virtual desktop system will now be described with reference to FIG. 2. The server apparatus 20 has VMs 230a and 230b, a hypervisor 235, a graphics processing unit (GPU) 240, and a GPU sharing mechanism 245.

Each of the VMs 230a and 230b is assigned resources, such as a CPU and a memory, of the server apparatus 20 and operates as a virtual machine. The hypervisor 235 is software for operating and managing the VMs 230a and 230b on the server apparatus 20. The GPU 240 is a semiconductor chip (graphics board) that executes calculation processing used for graphics rendering. The GPU sharing mechanism 245 is a mechanism that allows multiple graphics applications to share and simultaneously use the single GPU 240.

In the example in FIG. 2, graphics applications 220a and 220b operate on operating systems (OSs) 210a and 210b incorporated into the VMs 230a and 230b, respectively. The OSs 210a and 210b execute rendering of desktop screens and display screens by using the corresponding graphics applications 220a and 220b. The graphics applications 220a and 220b also outputs instructions (rendering instructions) for using a graphics accelerator in the GPU 240, in order to realize high-speed screen rendering, as in a computer-aided design (CAD) application. The rendering instructions are sent to the GPU sharing mechanism 245 provided exterior to the VMs 230a and 230b. The GPU sharing mechanism 245 is a mechanism for virtualizing the GPU 240 so as to enable the VMs 230a and 230b to share the GPU 240 at the same time. The rendering instructions output from the graphics applications 220a and 220b are executed simultaneously by the GPU 240.

Results of the rendering by the GPU 240 are sent from the GPU 240 to the graphics applications 220a and 220b via the GPU sharing mechanism 245 and are rendered on rendering areas on the corresponding VMs 230a and 230b. The graphics accelerator in the GPU 240 is implemented by hardware, such as a video chip, or hardware, such as a video card having a video chip. The graphics accelerator in the GPU 240 can perform high-performance rendering processing, compared with the rendering processing executed using software on the VMs 230a and 230b.

The GPU 240 executes rendering on only areas (for example, rendering areas BO in FIG. 2) in which models of the graphics applications 220a and 220b are to be rendered. Other areas (for example, rendering areas AO in FIG. 2), such as a desktop screen and a window menu, are rendered using the OSs or software on the OSs, without using the GPU 240.

A large amount of rendering instructions and image data of rendering results is transferred between the graphics applications 220a and 220b and the GPU sharing mechanism 245 (the GPU 240). Thus, when the number of VMs on the server apparatus 20 increases, the data transfer becomes a bottleneck, which may deteriorate operation responsiveness in the graphics applications 220a and 220b.

When the server apparatus 20 combines the image data resulting from rendering by the GPU 240 and the image data resulting from rendering using the OS or the software on the OS, the load on the processing in the server apparatus 20 during transfer of a screen to the client apparatus increases.

Accordingly, an embodiment described below proposes a system in which a GPU sharing mechanism 245 and a thin-client system are caused to cooperate with each other to reduce the load on the processing in the server apparatus 20 during transfer a screen to a client apparatus.

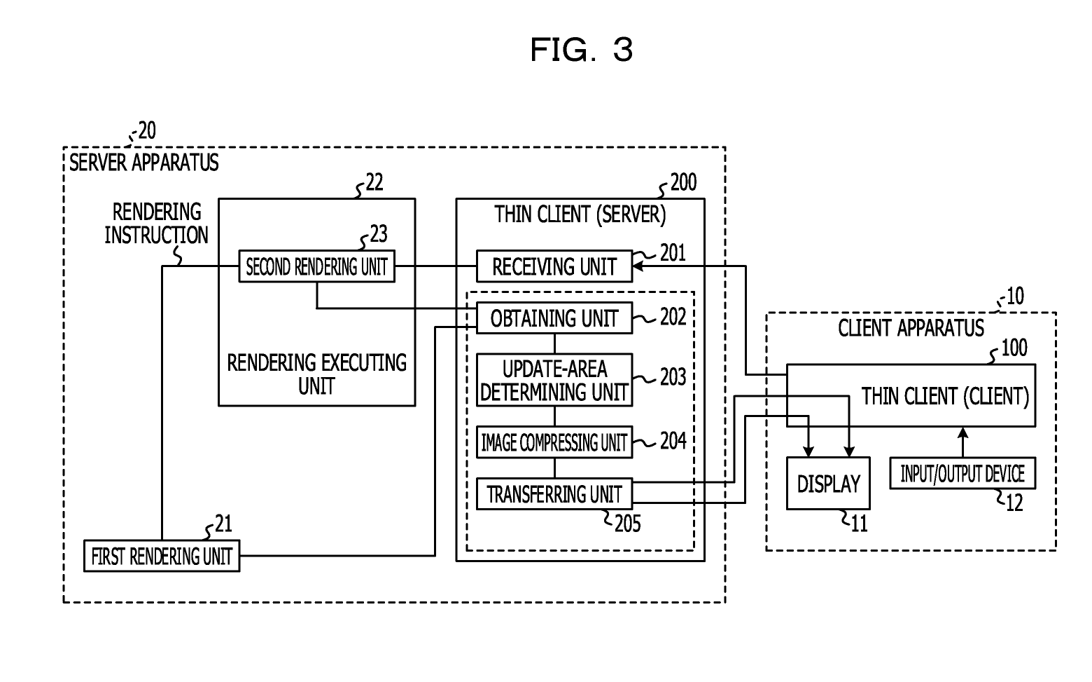

The system according to the present embodiment is not limited to the configuration of the virtual desktop system illustrated in FIG. 2. The system according to the present embodiment may have any configuration in which a server apparatus 20 transfers an image subjected to rendering processing using a GPU 240 and an image subjected to rendering processing without using the GPU 240 and a client apparatus 10 can combine the images and render the combined image. The configurations and the operations of a client apparatus 10 and a server apparatus 20 in the first embodiment will be described below with reference to FIG. 3.

### FIRST EMBODIMENT

### Functional Configuration of Client Apparatus

A brief description will be given of a functional configuration of one client apparatus 10 according to the first embodiment of the present disclosure. The client apparatus 10 has a thin-client client 100, a display 11, and an input/output device 12. A computer executes a thin-client client program to implement the thin-client client 100. The thin-client client 100 receives screen update information including image data from a thin-client server 200, decompresses the screen update information, and then renders the resulting screen update information on a display 11. The thin-client client 100 also obtains, from the input/output device 12, an input/output event for remotely operating a desktop screen generated by the server apparatus 20 and transfers the details of the input/output event to the thin-client server 200. The input/output device 12 includes devices, such as a keyboard and a mouse, for performing input/output operation. The input/output device 12 is not limited to a keyboard and a mouse, and may be any equipment that allows for input/output operation. The display 11 may also be provided external to the client apparatus 10.

### Functional Configuration of Server Apparatus

Next, a functional configuration of a server apparatus 20 according to the first embodiment of the present disclosure will now be described with reference to FIG. 3. In a virtual desktop environment on a VM provided by the server apparatus 20, a desktop screen provided by the thin-client server 200 is used by the thin-client client 100 through a network. A computer realizes a thin-client server program to execute the thin-client server 200.

The server apparatus 20 has a first rendering unit 21, a rendering executing unit 22, and the thin-client server 200. The first rendering unit 21 has a GPU 240. The rendering executing unit 22 has a second rendering unit 23.

The thin-client server 200 receives an input event from the thin-client client 100 and passes the input event to the rendering executing unit 22 to perform rendering processing. The rendering executing unit 22 outputs a rendering instruction to cause the first rendering unit 21 to execute rendering by using the GPU 240 or causes the second rendering unit 23 to perform rendering processing without using the GPU 240. The rendering executing unit 22 is a function on a VM. The second rendering unit 23 operates on an OS on the VM. The second rendering unit 23 may be, for example, rendering software that runs on the OS.

The thin-client server 200 has a receiving unit 201, an obtaining unit 202, an update-area determining unit 203, an image compressing unit 204, and a transferring unit 205.

The receiving unit 201 receives an input event transmitted from the thin-client client 100. The received input event is sent to the rendering executing unit 22.

The obtaining unit 202 obtains image data (hereinafter referred to as “first image data”) that is part rendered by the first rendering unit 21 and image data (hereinafter referred to as “second image data”) that is part rendered by the second rendering unit 23.

The update-area determining unit 203 determines an area updated on a desktop screen.

The image compressing unit 204 obtains desktop-screen image data (such as difference information) in which a result subjected to the rendering processing is reflected and compresses the image data. The desktop-screen image data in which the result subjected to the rendering processing is reflected serves as the first image data and the second image data.

The transferring unit 205 transmits screen update information having compressed data and rendering-position information to the thin-client client 100.

### Operation of Thin-Client Server

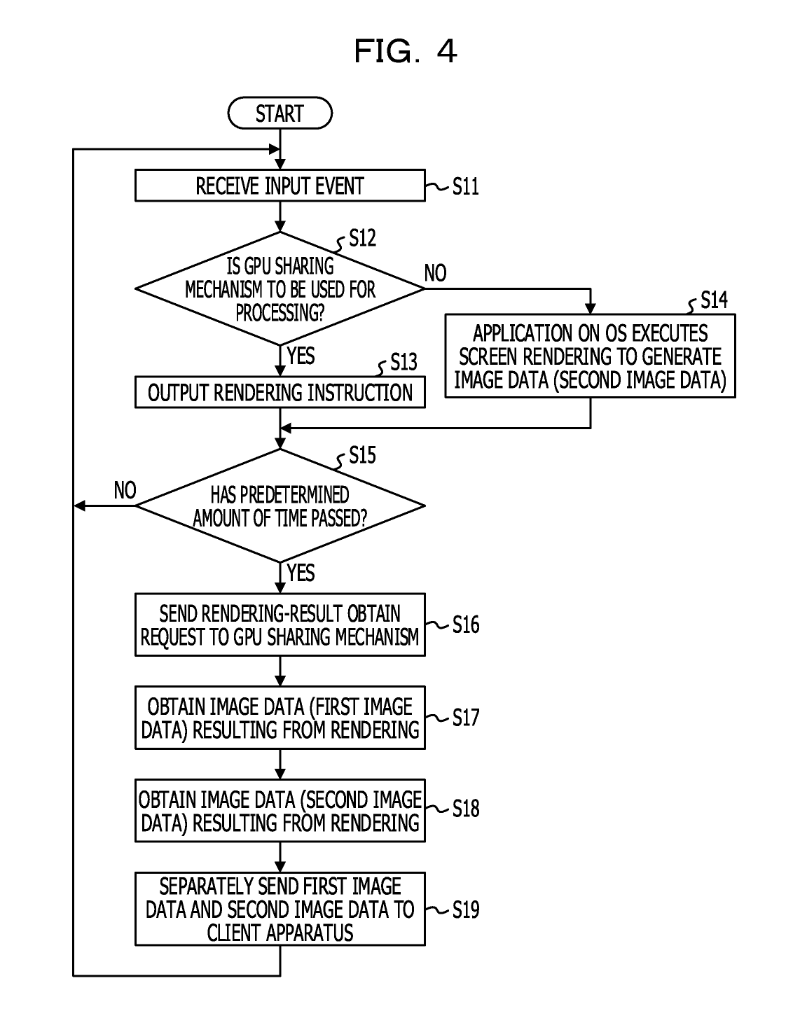

An operation of the thin-client server 200 according to the first embodiment will be described next with reference to FIG. 4. FIG. 4 is a flowchart illustrating processing executed by the thin-client server 200.

First, the receiving unit 201 receives an input event from the client apparatus 10 (in S11). The input event is sent to the rendering executing unit 22. The rendering executing unit 22 determines whether or not the GPU 240 is to be used to perform rendering processing (in S12). When it is determined that the GPU 240 is to be used to perform rendering processing, the rendering executing unit 22 outputs a rendering instruction to the GPU sharing mechanism 245 (in S13). On the other hand, when it is determined that the GPU 240 is not to be used to perform rendering processing, the rendering executing unit 22 uses the second rendering unit 23 (the application software on the OS) to execute rendering to generate second image data (in S14).

Next, in S15, the obtaining unit 202 determines whether or not a predetermined amount of time has passed. When the predetermined amount of time has not passed, the process returns to S11. When the predetermined amount of time has passed, the obtaining unit 202 sends a rendering-result obtain request to the GPU sharing mechanism 245 (in S16). The obtaining unit 202 obtains first image data resulting from the rendering processing performed using the GPU 240 (in S17). The obtaining unit 202 obtains second image data resulting from the rendering processing performed by the second rendering unit 23 (in S18). The transferring unit 205 separately sends the obtained first image data and the obtained second image data, which is a result of the rendering using the second rendering unit 23, to the thin-client client 200 (in S19). The first image data and the second image data sent to the thin-client client 200 are displayed on the display 11 as desktop-screen update information.

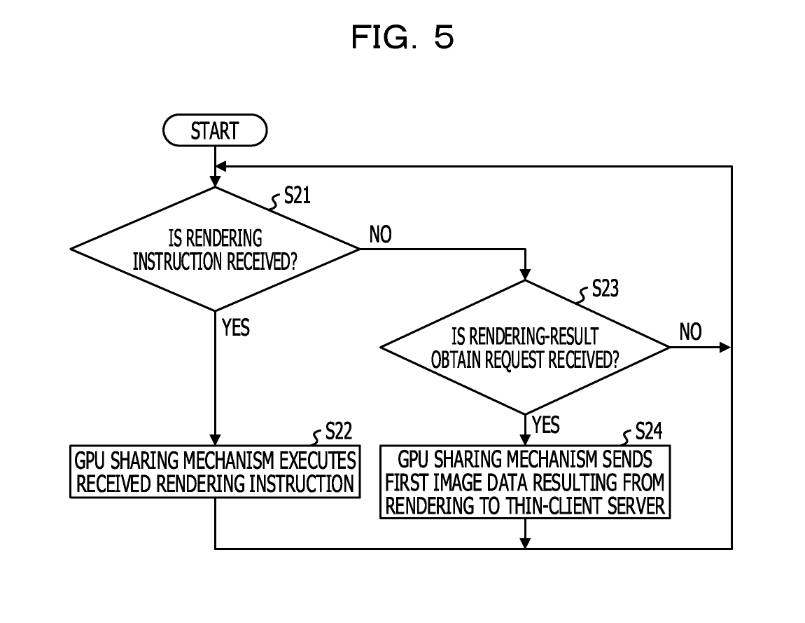

### Operation of GPU Sharing Mechanism

[FROM FERE] Next, an operation of the GPU sharing mechanism 245 according to the first embodiment will be described with reference to FIG. 5. FIG. 5 is a flowchart illustrating processing executed by the GPU sharing mechanism 245.

The GPU sharing mechanism 245 determines whether or not a rendering instruction is received (in S21). When a rendering instruction is received, the GPU sharing mechanism 245 uses the GPU 240 to execute the received rendering instruction (in S22), and enters a state for waiting for a rendering instruction or the like. When a rendering instruction is not received in S21, the GPU sharing mechanism 245 determines whether or not a rendering-result obtain request is received (in S23). When a rendering-result obtain request is received, the GPU sharing mechanism 245 sends the first image data resulting from rendering to the thin-client server 200 (in S24) and then returns to the state for waiting for a rendering instruction or the like. When a rendering-result obtain request is not received in S23, the GPU sharing mechanism 245 returns to the state for waiting for a rendering instruction or the like.

### Operation of Thin-Client Client

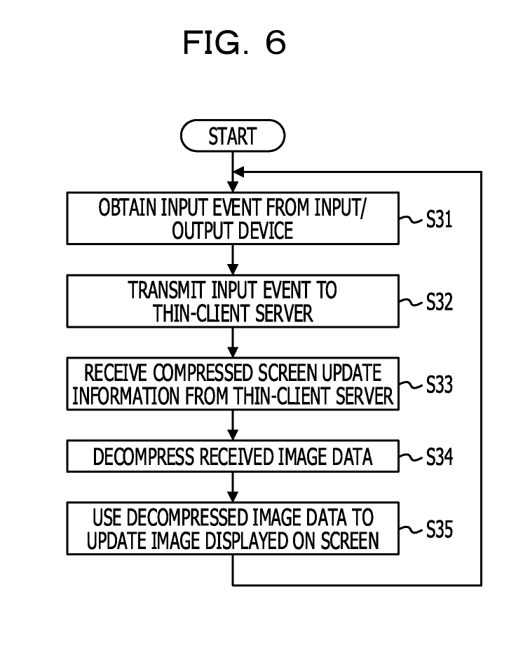

Next, an operation of the thin-client client 100 according to the first embodiment will be described with reference to FIG. 6. FIG. 6 is a flowchart illustrating processing executed by the thin-client client.

The thin-client client 100 obtains an input event from the input/output device 12 connected to the client apparatus 10 (in S31). Next, the thin-client client 100 transmits the obtained input event to the thin-client server 200 (in S32). The thin-client client 100 also receives screen update information from the thin-client server 200 (in S33). The thin-client client 100 decompresses the first image data and the second image data included in the screen update information (in S34). The thin-client client 100 uses the decompressed image data to update the image displayed on the desktop screen on the client apparatus 10 (in S35), and returns to the processing for obtaining an input event.

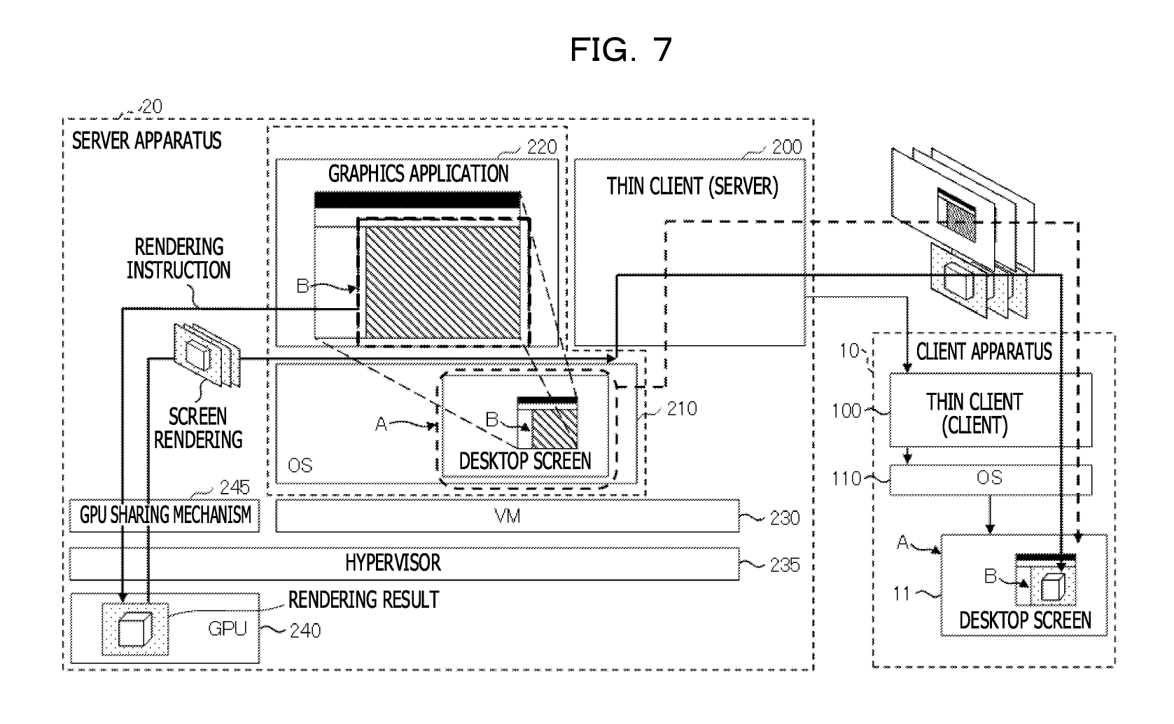

According to the above-described image transfer method in the first embodiment, the rendering processing in the server apparatus 20 is performed by the first rendering unit 21 that executes rendering using the GPU 240 and the second rendering unit 23 that executes rendering on an OS 210 of a VM 230 without using the GPU 240. For example, on a desktop screen A illustrated in FIG. 7, the second rendering unit 23 generates screen image data (second image data) for an area other than an area B indicated by hatching. The first rendering unit 21 generates screen image data (first image data) for the area B. In this case, the first rendering unit 21 executes only rendering processing using the GPU 240 in response to a rendering instruction and does not transfer image data resulting from the executed rendering processing to a graphics application 220 on the VM 230. As a result, only an image for the area other than the area B is displayed on the screen in the graphics application 220

The thin-client server 200 obtains the first image data from the GPU sharing mechanism 245 asynchronously with the timing of generation of the first image data, at timing of transfer of an image to the client apparatus 10. As a result, the number of rendering-result transfers executed between the GPU sharing mechanism 245 and the thin-client server 200 in response to respective rendering instructions is reduced to the number of transfers of images to the client apparatus 10, thus making it possible to reduce the amount of data to be transferred. This reduces the load on the processing in the server apparatus 20 and increases the number of VMs that can be accommodated into the server apparatus 20, thus making it possible to reduce the cost.

The server apparatus 20 does not perform processing for combining the first image data and the second image data. The first image data and the second image data are separately transferred to and combined by the thin-client client 100. A desktop screen resulting from the combination is displayed on the display 11 of the client apparatus 10. This arrangement makes it possible to reduce the load on the processing in the server apparatus 20 when a screen is transferred to the client apparatus 10.

### SECOND EMBODIMENT

Next, a description will be given of the server apparatus 20 in a second embodiment of the present disclosure. In the first embodiment, the server apparatus 20 separately transfers the first image data and the second image data to the client apparatus 10 at the timing of transferring a desktop screen.

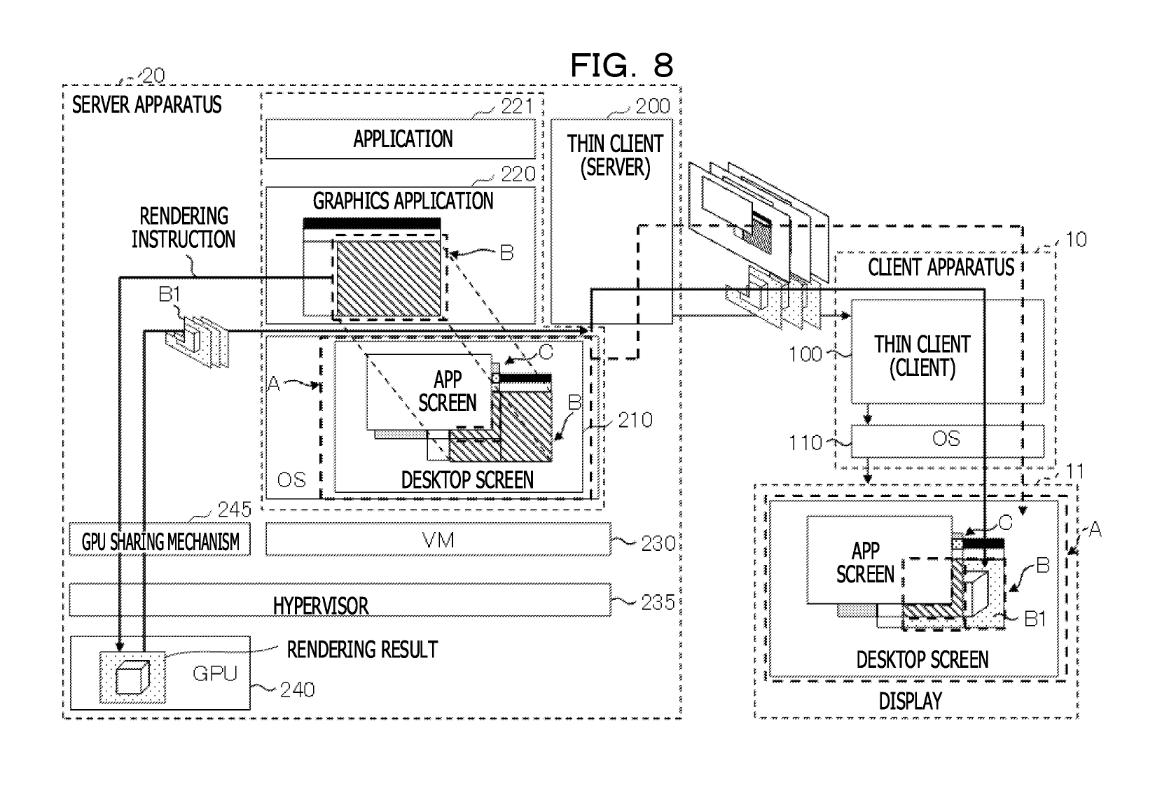

According to the method described above, as illustrated in FIG. 8, the second image data (resulting from rendering by the desktop screen A) and the first image data (resulting from rendering in the area B by the GPU 240) are separately transferred. Thus, when the rendering area (the desktop screen A) of the second image data and the rendering area (the area B) of the first image data overlap each other on a screen and a transparent display area in which one of the first image data and the second image data is transparently seen from the other image data exists in the overlap area, a flaw may occur in an image displayed on the client apparatus 10.

More specifically, the GPU sharing mechanism 245 manages only the first image data resulting from the rendering by the GPU 240. With respect to an arbitrary window rendered on the desktop screen A, the thin-client server 200 obtains, from the OS 210, information regarding a top-and-bottom relationship in an area where the first image data and the second image data overlap each other. The “arbitrary window” as used herein refers to, for example, a window launched by another application. In FIG. 8, the arbitrary window is displayed as an “app screen”. When the second image data for rendering a window portion overlaps the first image data resulting from rendering by the GPU 240, the thin-client server 200 transfers the first image data of an area B1 that remains by excluding, from the first image data, the window-overlapping portion and a portion in which the rendered image is updated on the desktop screen A. In this case, the first image data is transferred to the thin-client client 100 separately from the second image data.

The thin-client client 100 directly combines the first image data of the remaining area B1 excluding the portion having the overlap and the second image data, the first image data and the second image data being separately transmitted from the thin-client server 200, and displays the combined image. Thus, when there is an area in which the window is transparently displayed with the rendering area of the GPU 240 being as a background (that is, when there is an L-shaped area C displayed on the OS 210 in FIG. 8) the first image data of the remaining area B1 obtained by deleting the data of the window-overlapping portion from the rendering result of the GPU 240 does not include the image rendered in the background of the area C in the transparent portion.

Thus, when the thin-client client 100 combines the first and second image data and renders the combined image on the display 11, an image to be transparently displayed as a background in the area C in the transparent portion is not rendered. As a result, an unnatural image having a mismatch therein is displayed, like that in the hatched portion in the area C rendered on the display 11. In the second embodiment below, a description will be given of the server apparatus 20 that provides the client apparatus 10 with an image that does not have a mismatch therein even in an area in a transparent portion.

### Functional Configuration of Server Apparatus

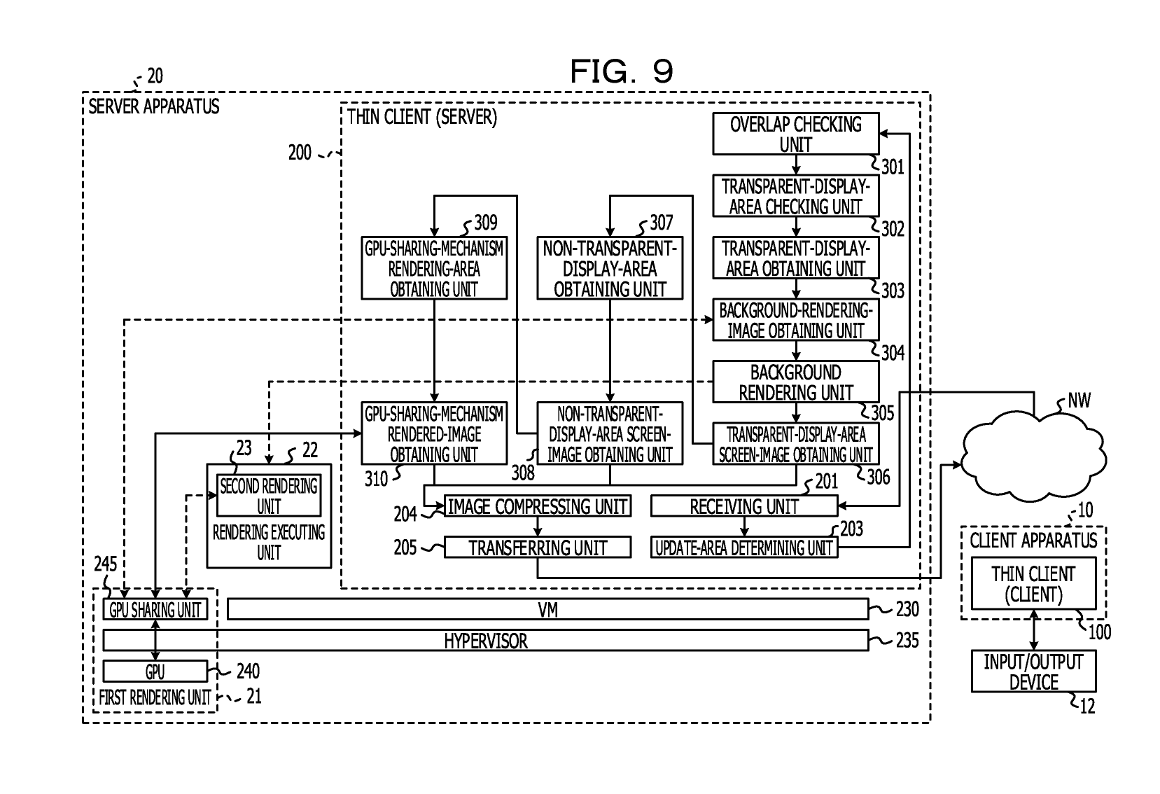

First, a functional configuration of a server apparatus 20 according to the second embodiment will be described with reference to FIG. 9. FIG. 9 is a functional block diagram of the server apparatus 20 according to the second embodiment.

A thin-client server 200 includes a receiving unit 201, an update-area determining unit 203, an image compressing unit 204, a transferring unit 205, an overlap checking unit 301, a transparent-display-area checking unit 302, a transparent-display-area obtaining unit 303, a background-rendering-image obtaining unit 304, a background rendering unit 305, a transparent-display-area screen-image obtaining unit 306, a non-transparent-display-area obtaining unit 307, a non-transparent-display-area screen-image obtaining unit 308, a GPU-sharing-mechanism rendering-area obtaining unit 309, and a GPU-sharing-mechanism rendered-image obtaining unit 310.

The receiving unit 201 obtains, from a thin-client client 100, an input/output event obtained from an input/output device 12 and sends the input/output event to a rendering executing unit 22.

The update-area determining unit 203 periodically obtains images displayed on the desktop screen and determines an area where an update was performed.

The overlap checking unit 301 determines whether or not a desktop-screen rendering area (another window) and a rendering area of a GPU sharing mechanism 245 (a GPU 240) have an overlap in the updated area detected by the update-area determining unit 203.

When the overlap checking unit 301 determines that there is an overlap, the transparent-display-area checking unit 302 determines whether or not a transparently displayed area exists in the area having the overlap.

When the transparent-display-area checking unit 302 determines that a transparent display area exists, the transparent-display-area obtaining unit 303 separately extracts the transparently displayed area and a non-transparently displayed area.

The background-rendering-image obtaining unit 304 obtains, from the GPU sharing mechanism 245, the screen image rendered in the transparently displayed area.

The background rendering unit 305 renders only a background in the transparently displayed area, based on the rendered screen image obtained by the background-rendering-image obtaining unit 304. The transparent-display-area screen-image obtaining unit 306 obtains a screen display image in the transparently displayed area. As a result, of the first image data, the image data of the background portion in the transparent display area in the overlap area is obtained, and a screen display image in the transparently displayed area, the display image of the background potion being combined with the screen display image, is obtained.

The non-transparent-display-area obtaining unit 307 obtains a non-transparently displayed area extracted by the transparent-display-area obtaining unit 303. The non-transparent-display-area screen-image obtaining unit 308 obtains a screen display image in the non-transparently displayed area. As a result, the second image data is obtained.

Based on the updated area, the transparently displayed area, and the non-transparently displayed area, the GPU-sharing-mechanism rendering-area obtaining unit 309 calculates a rendering area of the GPU sharing mechanism 245, the screen display image being to be updated in the rendering area.

The GPU-sharing-mechanism rendered-image obtaining unit 310 obtains, from the GPU sharing mechanism 245, the screen image rendered in the rendering area of the GPU sharing mechanism 245 and to be updated. As a result, the image of a non-overlap area in the first image data is obtained.

The image compressing unit 204 compresses the screen image data obtained by the transparent-display-area screen-image obtaining unit 306, the non-transparent-display-area screen-image obtaining unit 308, and the GPU-sharing-mechanism rendered-image obtaining unit 310. The transferring unit 205 transmits screen update information having the data processed by the image compressing unit 204 and rendering-position information to the thin-client client 100.

### Operation of Thin-Client Server

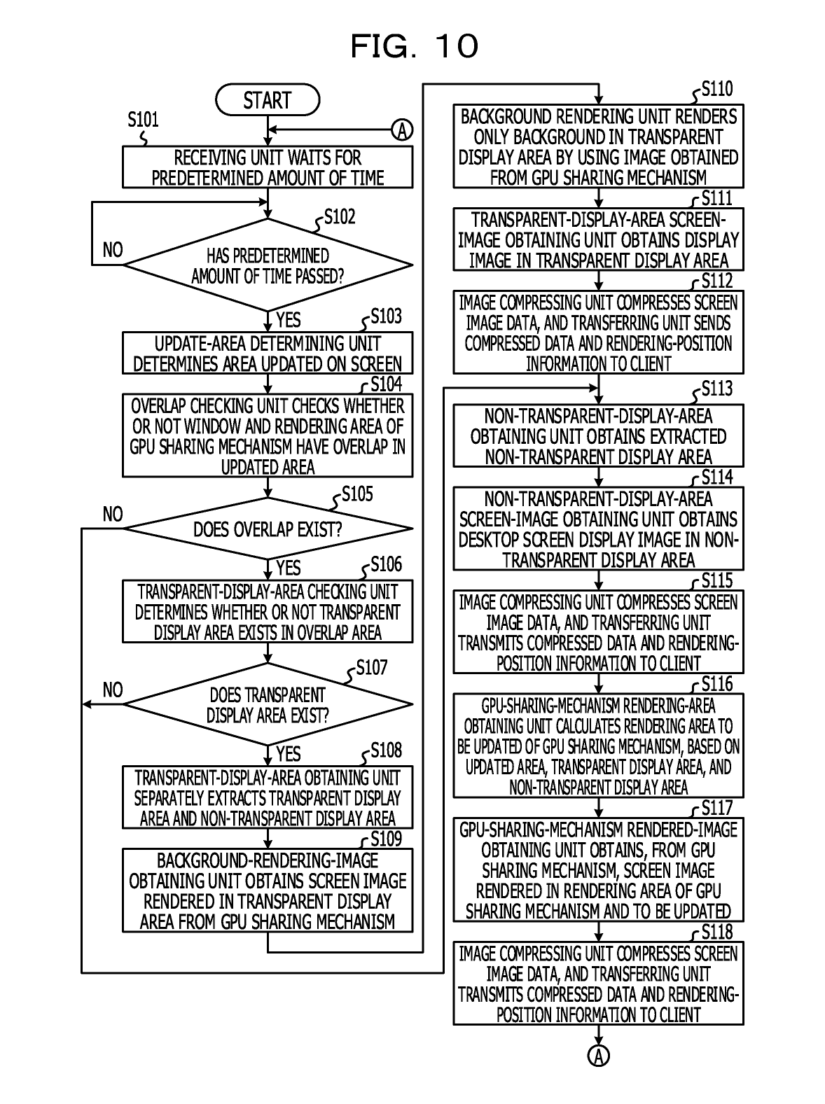

Next, an operation of the thin-client server 200 according to the second embodiment will be described with reference to FIG. 10. FIG. 10 is a flowchart illustrating processing executed by the thin-client server. Since operations of the GPU sharing mechanism 245 and the thin-client client 100 are the same as or similar to those in the first embodiment, descriptions thereof are not given hereinafter.

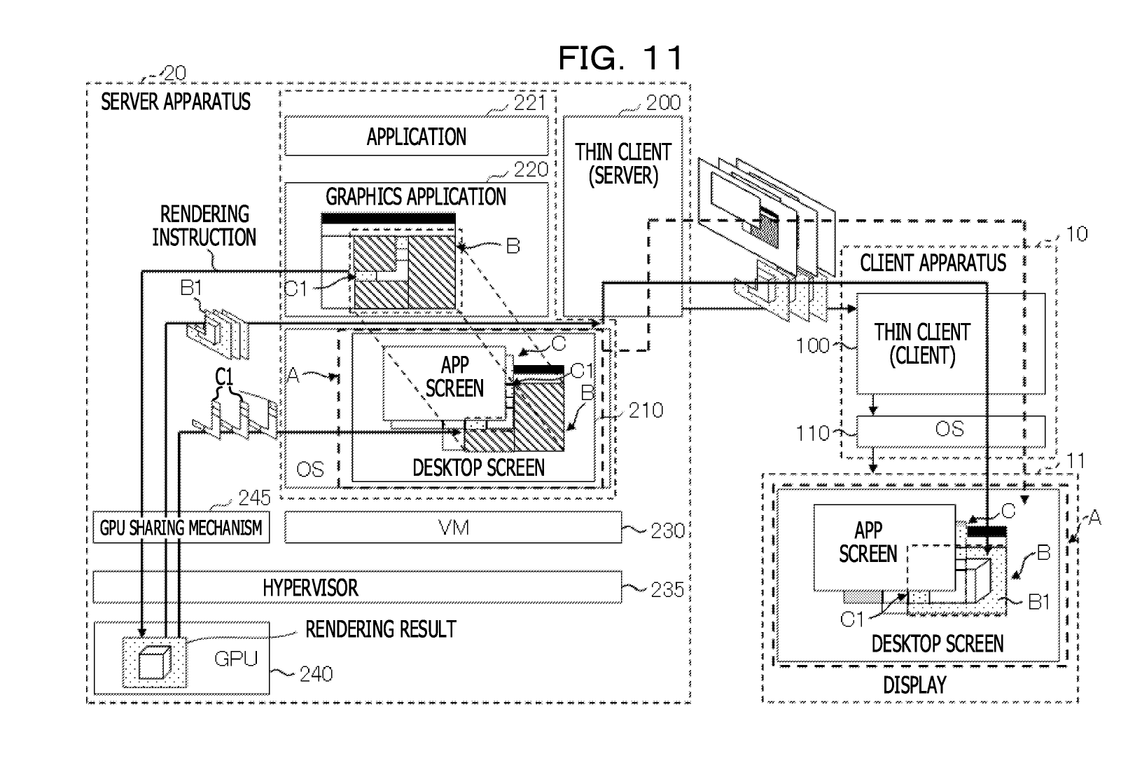

The receiving unit 201 waits for a predetermined amount of time in order to perform periodical processing (in S101). The receiving unit 201 determines whether or not the predetermined amount of time has passed (in S102), and returns to the waiting state until the predetermined amount of time passes. When the predetermined amount of time has passed, the update-area determining unit 203 determines an area updated on a screen (in S103). The overlap checking unit 301 determines whether or not a desktop-screen rendering area (including another window) and a rendering area of the GPU sharing mechanism 245 (the GPU 240) have an overlap area in the updated area (in S104 and S105). For example, in the example in FIG. 11, the overlap checking unit 301 determines whether or not a desktop-screen rendering area A (including a window launched by another application) and a rendering area B of the GPU sharing mechanism 245 (the GPU 240) have an overlap area in the updated area.

When it is determined that there is no overlap area, the process advances to process S113 to be executed by the non-transparent-display-area obtaining unit 307. In this case, as illustrated in FIG. 11, the desktop-screen rendering area A and the rendering area B have an overlap at a portion on the app screen. When it is determined that there is an overlap area, the transparent-display-area checking unit 302 determines whether or not a transparent display area exists in the overlap area (in S106 and S107). When it is determined that no transparent display area exists, the process advances to process in S113 to be executed by the non-transparent-display-area obtaining unit 307.

In FIG. 11, the desktop-screen rendering area A and the rendering area B have a transparent display area C in the portion having the overlap. When it is determined that a transparent display area exists in such a manner, the transparent-display-area obtaining unit 303 separately extracts the transparent display area and a non-transparent display area (in S108). The background-rendering-image obtaining unit 304 obtains the screen image rendered in the transparent display area from the first image data held in the GPU sharing mechanism 245 (in S109). The background rendering unit 305 renders only a background in the transparent display area by using the rendered screen image obtained from the GPU sharing mechanism 245 (in S110). As a result, with respect to the portion that exists in the transparent display area C in FIG. 11 and that overlaps the area B, an image C1 of the background portion extracted from the first image data is rendered.

Next, the transparent-display-area screen-image obtaining unit 306 obtains, from the second image data, the display image in the transparent display area on the desktop screen A (in S111). As a result, the image displayed in the transparent display area C on the desktop screen A in FIG. 11 is obtained from the second image data.

The image compressing unit 204 compresses the obtained image data, and then the transferring unit 205 sends screen update information having the compressed data and rendering-position information to the thin-client client 100 (in S112).

The non-transparent-display-area obtaining unit 307 obtains the extracted non-transparent display area (in S113). The non-transparent-display-area screen-image obtaining unit 308 obtains the desktop screen display image in the non-transparent display area (in S114). As a result, the image data of the area other than the transparent display area C and the rendering area B of the GPU sharing mechanism 245 (the GPU 240) is obtained out of the second image data on the desktop screen A in FIG. 11.

The image compressing unit 204 compresses the obtained image data, and then the transferring unit 205 transmits screen update information having the compressed data and rendering-position information to the thin-client client 100 (in S115).

Next, based on the updated area, the transparent display area, and the non-transparent display area, the GPU-sharing-mechanism rendering-area obtaining unit 309 calculates a rendering area to be updated of the GPU sharing mechanism 245 (in S116). The GPU-sharing-mechanism rendered-image obtaining unit 310 obtains, from the GPU sharing mechanism 245, the screen image rendered in the rendering area of the GPU sharing mechanism 245 and to be updated (in S117). As a result, of the first image data in the rendering area B, the image data of an area B1 other than the portion that overlaps the app screen and the transparent display area C is obtained from the first image data illustrated in FIG. 11.

The image compressing unit 204 compresses the obtained image data, and then the transferring unit 205 transmits screen update information having the compressed data and rendering-position information to the thin-client client 100 (in S118). The process then returns to the first process (in S101) in which the predetermined amount of time is waited for.

### EXAMPLE

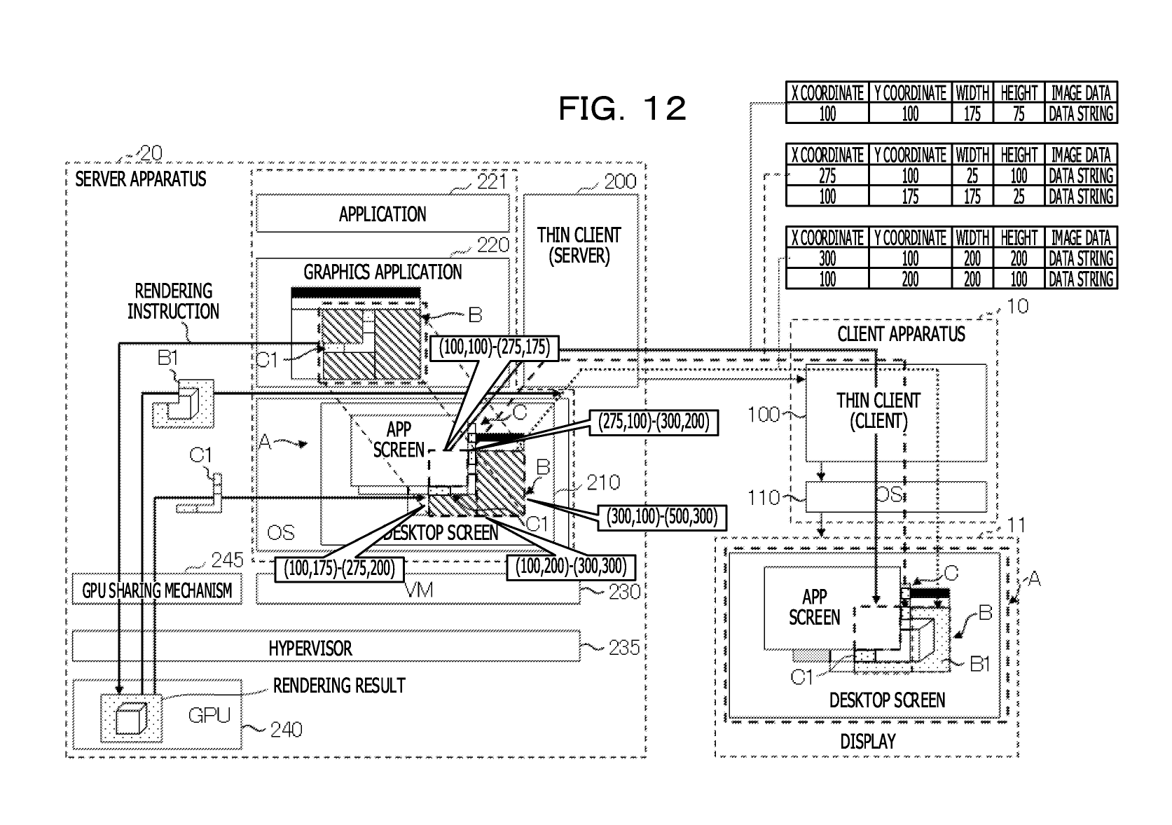

In this example, the second embodiment described above will be described in more detail with reference to FIG. 12. In this example, an area C in which the window background is transparently displayed is detected in the area where the rendering area B of the GPU sharing mechanism 245 and the rendering area A including another application window overlap each other. An image C1 in an area included in the background is obtained from the GPU sharing mechanism 245 and is rendered. In this example, the image C1 in the background is combined with the window and the desktop screen display image in the background, and the combined screen display image is transferred to the thin-client client 100.

A description will be given of a flow of processing in this example. In this example, data [x, y, w, h] using an X coordinate x, a Y coordinate y, the width w of a rendering area, and the height h of the rendering area is used as rendering-position information. In this case, the data [x, y, w, h] sequentially indicates, from its left side, an X coordinate x at an upper left portion of an area, a Y coordinate y at the upper left of the area, a width w from the position of the coordinates (x, y), and a height h from the position of the coordinates (x, y).

Coordinates (x1, y1)-(x2, y2) using an X coordinate x1 of the upper left portion in an area, a Y coordinate y1 at the upper left portion in the area, an X coordinate x2 at the lower right portion in the area, and a Y coordinate y2 at the lower right portion in the area are used as values representing the area. The same representation is also used in an example below.

For convenience of description, the coordinate system of the desktop screen A and the coordinate system of the rendering area of the GPU 240 are assumed to be the same. However, the coordinate system of the desktop screen A and the coordinate system of the GPU 240 may be different from each other. In such a case, one of the coordinate systems is converted using a predetermined conversion mechanism so as to match the other coordinate system.

In this example, although (the X coordinate of the upper left portion, the Y coordinate of the upper left portion)−(the X coordinate of the lower right portion, the Y coordinate of the lower right portion) is used as a value representing an area, the present disclosure is limited to this representation and information, and another representation may also be used. In addition, although a combination of the X and Y coordinates of a rendering position and the width and the height of a rendering area is used as the rendering-position information, the present disclosure is not limited to the position information, and another position information may also be used. These points also apply to the following examples.

Operations of the GPU sharing mechanism 245 and the thin-client client 100 are the same as or similar to those in the first embodiment. The operation of the GPU sharing mechanism 245 is described below in order to clearly explain position information in part of processing, and the operation of the thin-client client 100 is not given hereinafter.

### Operation Example of GPU Sharing Mechanism

An operation of the GPU sharing mechanism 245 in this example will now be described with reference to FIG. 5.

The GPU sharing mechanism 245 determines whether or not a rendering instruction is received (in S21). When a rendering instruction is received, the GPU sharing mechanism 245 uses the GPU 240 to execute the received rendering instruction (in S22), and returns to the state for receiving a rendering instruction or the like. When no rendering instruction is received in S21, the GPU sharing mechanism 245 determines whether or not a rendering-result obtain request is received (in S23). When a rendering-result obtain request (in FIG. 12, a rendering-result obtain request for coordinates [275, 100, 25, 100] and [100, 175, 175, 25]) is received, the GPU sharing mechanism 245 sends the first image data, which results from rendering, to the thin-client server 200 (in S24), and returns to the state for receiving a rendering instruction or the like. When no rendering-result obtain request is received in S23, the operation returns to the state for receiving a rendering instruction or the like.

### Operation Example of Server

Next, an operation of the thin-client server 200 according to this example will be described with reference to FIGS. 10 and 12. The receiving unit 201 waits for a predetermined amount of time (for example, 33 ms (which means 30 times per second)), in order to perform periodical processing (in S101). The receiving unit 201 determines whether or not the predetermined amount of time has passed (in S102), and returns to the waiting state until the predetermined amount of time passes. When the predetermined amount of time has passed, the update-area determining unit 203 determines an updated area on the screen (in S103). In FIG. 12, it is assumed that an updated area having coordinates (100, 100)-(500, 300) is determined.

The overlap checking unit 301 determines whether or not the rendering area A on the desktop screen (including another window) and the rendering area B of the GPU sharing mechanism 245 (the GPU 240) overlap each other in the updated area. When it is determined that there is no overlap, the process advances to process S113 to be executed by the non-transparent-display-area obtaining unit 307. On the other hand, when it is determined that there is an overlap, the transparent-display-area checking unit 302 checks whether or not a transparent display area exists in the overlap area indicated by coordinates (100, 100)-(300, 200) in FIG. 12 (in S106 and S107). When it is determined that there is no transparent display area, the process advances to process in S113 to be executed by the non-transparent-display-area obtaining unit 307.

When it is determined that there is a transparent display area, the transparent-display-area obtaining unit 303 separately extracts the transparent display area and a non-transparent display area (in S108). In this example, it is determined that a transparent display area C indicated by coordinates (275, 100)-(300, 200) and (100, 175)-(275, 200) exists in the overlap area. That is, the transparent-display-area obtaining unit 303 separately extracts the transparent display area and a non-transparent display area (coordinates (100, 100)-(275, 175) in FIG. 12). The background-rendering-image obtaining unit 304 obtains the screen image rendered in the transparent display area from the GPU sharing mechanism 245 (in S109). By using the rendered screen image obtained from the GPU sharing mechanism 245, the background rendering unit 305 renders only a background in the transparent display area (in S110). The transparent-display-area screen-image obtaining unit 306 obtains the desktop screen display image in the transparent display area (in S111). The image compressing unit 204 compresses the obtained image data. Thereafter, the transferring unit 205 transmits the compressed data and rendering-position information (in FIG. 12, coordinates [275, 100, 25, 100], [100, 175, 175, 25]) to the thin-client client 100 as screen update information (in S112).

The non-transparent-display-area obtaining unit 307 obtains the extracted non-transparent display area (in S113). The non-transparent-display-area screen-image obtaining unit 308 obtains the desktop screen display image in the non-transparent display area (in S114). The image compressing unit 204 compresses the obtained image data. Thereafter, the transferring unit 205 transmits the compressed data and rendering-position information (in FIG. 12, coordinates [100, 100, 175, 75]) to the thin-client client 100 as screen update information (in S115).

Next, the GPU-sharing-mechanism rendering-area obtaining unit 309 calculates a rendering area to be updated (in FIG. 12, coordinates (100, 200)-(300, 300) and (300, 100)-(500, 300)) of the GPU sharing mechanism 245, based on the updated area, the transparent display area, and the non-transparent display area (in S116). The GPU-sharing-mechanism rendered-image obtaining unit 310 obtains, from the GPU sharing mechanism 245, the screen image rendered in the rendering area of the GPU sharing mechanism 245 and to be updated (in S117). The image compressing unit 204 compresses the obtained image data. Thereafter, the transferring unit 205 transmits the compressed data and rendering-position information (in FIG. 12, coordinates [100, 200, 200, 100] and [300, 100, 200, 200]) to the thin-client client 100 as screen update information (in S118). The process then returns to the first process in which the predetermined amount of time is waited for (in S101).

According to the image transfer method in the second embodiment, the rendering processing in the server apparatus 20 is performed by the first rendering unit 21 that executes rendering using the GPU 240 and the second rendering unit 23 that executes rendering on the OS 210 without using the GPU 240. Then, when the second image data for rendering a window portion overlaps the first image data resulting from the rendering by the GPU 240, the thin-client server 200 excludes the data for the window-overlapping portion from the first image data. The excluded first image data is transferred separately from the second image data.

In addition, in the present embodiment, when the window and the rendering area of the GPU 240 have an overlap area and a transparently displayed area exists in the overlap area, an image that is to be rendered in the background of the area in the transparent portion is extracted from the first image data rendered by the GPU 240. The extracted first image data is combined with the screen display image in the area of the transparent portion, and the combined screen display image is transferred to the thin-client client 100. This arrangement makes it possible to overcome the problem when rendered images overlap each other and allows the client apparatus 10 to render a screen having an appropriate display image.

In the present embodiment, the thin-client server 200 also obtains the first image data from the GPU sharing mechanism 245 asynchronously with the timing of generation of the first image data, according to the timing of transfer to the client apparatus 10. This arrangement makes it possible to suppress the amount of data transfer between the GPU sharing mechanism 245 and the thin-client server 200.

### THIRD EMBODIMENT

Next, a description will be given of the server apparatus 20 in a third embodiment of the present disclosure. A description in the second embodiment has been given of a method for extracting a rendering area and transferring an image when the first image data rendered by the GPU 240 is rendered in the background of a transparent display area in the overlap portion. In contrast, a description in the third embodiment is given of a method for extracting a rendering area and transferring an image when the first image data rendered by the GPU 240 is rendered in the foreground of a transparent display area in an overlap portion.

More specifically, in the third embodiment, a description will be given of an example in which an area in which a screen display of the GPU sharing mechanism 245 is partly transparently rendered exists in the background of the rendering area of the GPU sharing mechanism 245. In this example, an area in which the rendering area of the GPU sharing mechanism 245 is transparently displayed is detected from an area in which the rendering area of the GPU sharing mechanism 245 and the rendering area of the window of another application overlap each other, a foreground of the detected area is obtained from the GPU sharing mechanism 245, and rendering is performed. Then, the rendering area (foreground) of the GPU sharing mechanism 245 and the desktop screen display image of the window (background) are combined together, and the resulting screen display image is obtained and is transferred to the thin-client client 100.

### Functional Configuration of Server Apparatus

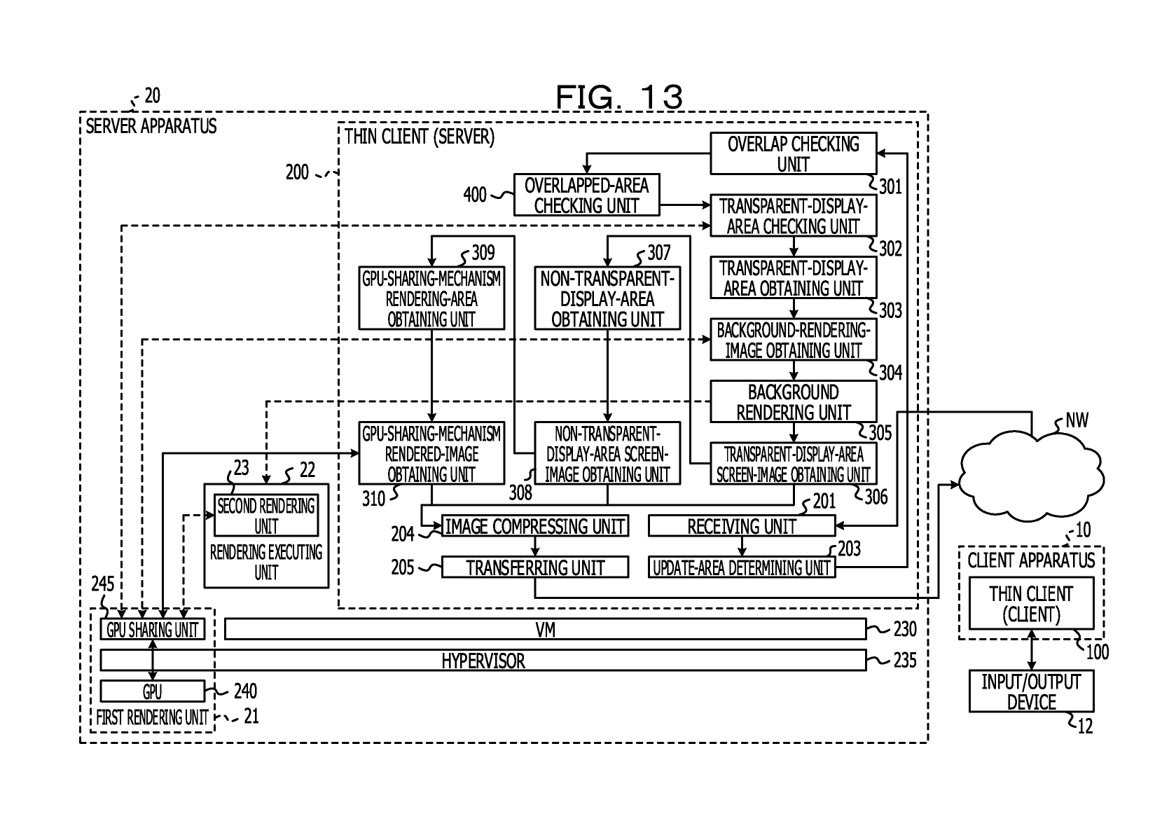

The functional configuration of a server apparatus 20 according to the third embodiment will now be described with reference to FIG. 13. Compared with the functional configuration of the server apparatus 20 according to the second embodiment illustrated in FIG. 9, the functional configuration of the server apparatus 20 according to the third embodiment is different from that of the server apparatus 20 according to the second embodiment in that an overlapped-area checking unit 400 is further provided. The overlapped-area checking unit 400 checks whether or not an area of the window in the updated area is overlapped by the rendering area of the GPU sharing mechanism 245.

### Operation of Thin-client server

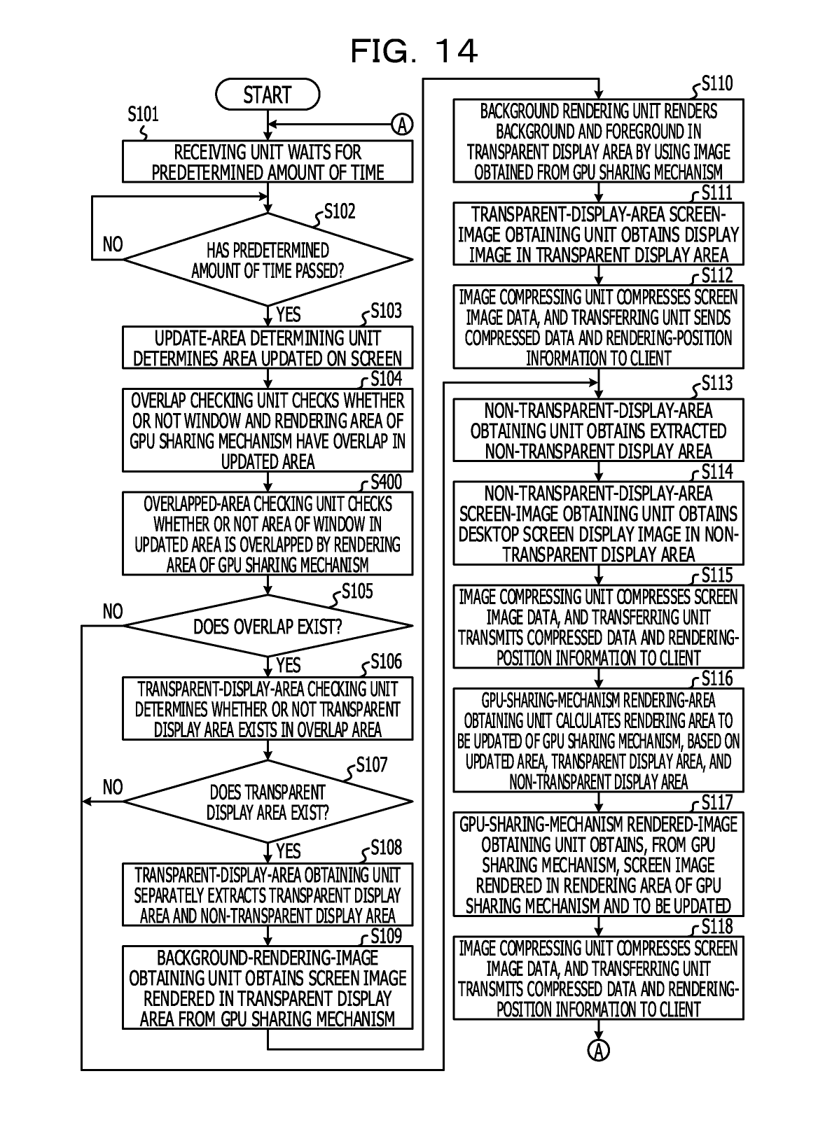

Next, an operation of the thin-client server 200 in the third embodiment will be described with reference to FIG. 14. FIG. 14 is a flowchart illustrating processing executed by the thin-client server. Since operations of a GPU sharing mechanism 245 and a thin-client client 100 are the same as or similar to those in the first and second embodiments, descriptions thereof are not given hereinafter.

However, in the present embodiment, in the operation of the GPU sharing mechanism 245 illustrated in FIG. 5, the rendering-result obtain request received in S23 is assumed to be a rendering-result obtain request for coordinates [100, 100, 200, 100]. When a rendering-result obtain request is received, the GPU sharing mechanism 245 sends the first image data resulting from rendering to the thin-client server 200. The process then returns to the state for receiving a rendering instruction or the like. When no rendering-result obtain request is received in S23 and a transparent-display-area obtain request is received, the GPU sharing mechanism 245 detects the coordinates (100, 100)-(300, 200) of a transparent display area from the image data resulting from rendering. Thereafter, the GPU sharing mechanism 245 sends the detected transparent display area to the thin-client server 200. The process then returns to the state for waiting for a rendering instruction or the like.

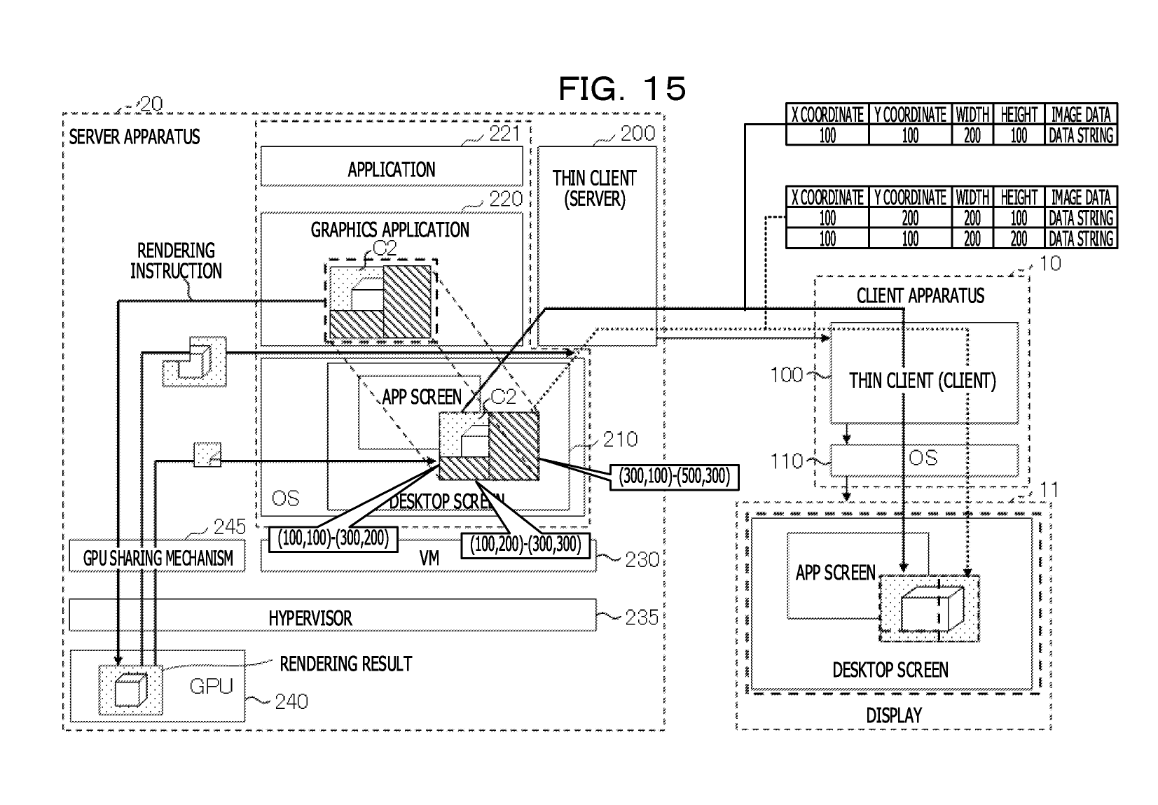

When the operation of the thin-client server 200 is started, the receiving unit 201 waits for a predetermined amount of time in order to perform periodical processing (in S101). When the predetermined amount of time has not passed, the receiving unit 201 returns to the waiting state (in S102). When the predetermined amount of time has passed, the update-area determining unit 203 determines an updated area in the screen display (in S103). In the example in FIG. 15, the update-area determining unit 203 determines that the updated area in the screen display is a range indicated by coordinates (100, 100)-(500, 300).

The overlap checking unit 301 checks whether or not the window and the rendering area of the GPU sharing mechanism 245 have an overlap area in the updated area (in S104). The overlapped-area checking unit 400 checks whether or not an area of the window in the updated area is overlapped by the rendering area of the GPU sharing mechanism 245 (in S400). When it is determined in S105 that there is no overlap area, the process advances to process in S113 to be executed by the non-transparent-display-area obtaining unit 307. When it is determined in S105 that there is an overlap area, the transparent-display-area checking unit 302 determines whether or not a transparent display area exists in the overlap area (including a case in which the area is overlapped by the rendering area of the GPU sharing mechanism 245) (in S106 and S107). When it is determined that there is no transparent display area, the process advances to process in S113 to be executed by the non-transparent-display-area obtaining unit 307.

In the present embodiment, it is determined that, as illustrated in FIG. 15, an area indicated by coordinates (100, 100)-(300, 200) exists in the overlap area as a transparent display area. When it is determined that a transparent display area exists, the transparent-display-area obtaining unit 303 separately extracts the transparent display area and a non-transparent display area (in S108). In this example, it is determined that a transparent display area (=(100, 100)-(300, 200)) exists in the overlap area. The background-rendering-image obtaining unit 304 obtains the screen image rendered in the transparent display area from the GPU sharing mechanism 245 (in S109). By using the rendered screen image obtained from the GPU sharing mechanism 245, the background rendering unit 305 renders a background and a foreground in the transparent display area (in S110).

Next, the transparent-display-area screen-image obtaining unit 306 obtains the display image of the desktop screen A in the transparent display area (in S111). The image compressing unit 204 compresses the obtained image data, and then, the transferring unit 205 transmits screen update information including the compressed data and rendering-position information (=[100, 100, 200, 100]) to the thin-client client 100 (in S112).

Next, the non-transparent-display-area obtaining unit 307 obtains the extracted non-transparent display area (in S113). The non-transparent-display-area screen-image obtaining unit 308 obtains the desktop screen display image in the non-transparent display area (in S114). The image compressing unit 204 compresses the obtained image data, and then the transferring unit 205 transmits the compressed data and rendering-position information to the thin-client client 100 as screen update information (in S115). That is to say, in S115, screen update information itself is not transmitted.

Next, based on the updated area, the transparent display area, and the non-transparent display area, the GPU-sharing-mechanism rendering-area obtaining unit 309 calculates a rendering area to be updated (in FIG. 15, coordinates (100, 200)-(300, 300) and (300, 100)-(500, 300)) of the GPU sharing mechanism 245 (in S116). The GPU-sharing-mechanism rendered-image obtaining unit 310 obtains, from the GPU sharing mechanism 245, the screen image rendered in the rendering area of the GPU sharing mechanism 245 and to be updated (in S117). The image compressing unit 204 compresses the obtained image data. Thereafter, the transferring unit 205 transmits screen update information having the compressed data and rendering-position information (in FIG. 15, coordinates [100, 200, 200, 100], [300, 100, 200, 200]) to the thin-client client 100 (in S118). The process then returns to the first processing in which the predetermined amount of time is waited for (in S101).

As described above, in the third embodiment, even in a case in which the first image data rendered by the GPU 240 is rendered in the foreground of a transparent display area in an overlap portion, when an area in which a window is transparently displayed with the rendering area of the GPU 240 being a foreground exists in the area of the overlap portion, an image to be rendered in the foreground of the area of the transparent portion (in FIG. 15, the foreground of an area C2) is extracted from the first image data rendered by the GPU 240, the extracted image is combined with the screen display image in the area of the transparent portion, and a screen display image resulting from the combination is transferred to the thin-client client 100. This arrangement makes it possible to overcome the problem when rendered images overlap each other and allows the client apparatus 10 to render a screen having an appropriate display image.

In the present embodiment, the thin-client server 200 obtains the first image data from the GPU sharing mechanism 245 asynchronously with the timing of generation of the first image data, according to the timing of transfer to the client apparatus 10. This arrangement makes it possible to suppress the amount of data transferred between the GPU sharing mechanism 245 and the thin-client server 200.

### Example of Hardware Configuration

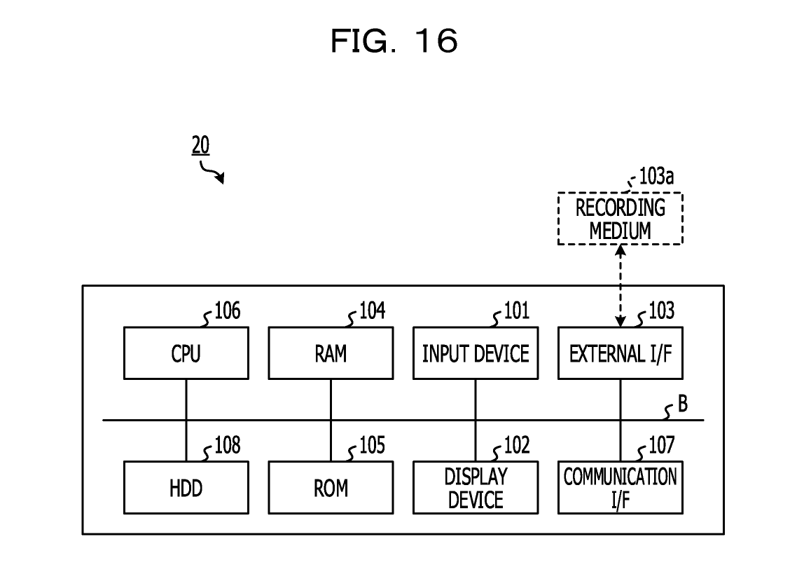

Lastly, the hardware configuration of the server apparatus 20 according to the present embodiment will be briefly described with reference to FIG. 16. FIG. 16 is a diagram illustrating an example of the hardware configuration of the server apparatus 20 according to the present embodiment.

As illustrated in FIG. 16, the server apparatus 20 has an input device 101, a display device 102, an external interface (I/F) 103, a random access memory (RAM) 104, a read only memory (ROM) 105, a central processing unit (CPU) 106, a communication I/F 107, and a hard disk drive (HDD) 108, which are coupled to each other through a bus B.

The input device 101 includes a keyboard and a mouse, and is used to input an operation to the server apparatus 20. The display device 102 includes a display and so on, and displays a desktop screen and so on.

The communication I/F 107 is an interface for connecting the server apparatus 20 to a network NW. With this arrangement, the server apparatus 20 transmits/receives data, such as image data, to/from each client apparatus 10 via the communication I/F 107.

The HDD 108 is a nonvolatile storage device in which programs and data are stored. Examples of the stored programs and data include an operating system (OS), which is a basic software for controlling the entire apparatus, and application software for providing various functions, such as a rendering function, on the OS. The HDD 108 stores therein a program executed by the CPU 106 in order to perform image generation processing and image transfer processing in each embodiment described above.

The external I/F 103 is an interface for an external device. The external device is, for example, a recording medium 103a. The server apparatus 20 can perform reading from and/or writing to the recording medium 103a via the external I/F 103. Examples of the recording medium 103a include a compact disk (CD) a digital versatile disk (DVD), a secure digital (SD) memory card, and a Universal Serial Bus (USB) memory.

The ROM 105 is a nonvolatile semiconductor memory (storage device) and stores therein a basic input/output system (BIOS) executed during startup and programs for OS setting, and network setting, and so on, as well as data. The RAM 104 is a volatile semiconductor memory (storage device) that temporarily stores a program and data therein. The CPU 106 is a computing device for controlling the entire apparatus and realizing equipped functions by reading a program and data from the storage device (for example, the HDD 108 or the ROM 105) to the RAM 104 and executing processing.

A program installed in the HDD 108 causes the CPU 106 to execute processing that realizes the rendering executing unit 22, the second rendering unit 23, and the units in the thin-client server 200, as well as the GPU control performed by the first rendering unit 21. The image data and so on the desktop screen may be realized, for example, by using, the RAM 104, the HDD 108, or a storage device connected to the server apparatus 20 through the network NW.

For example, a computer executes a thin-client server program installed in the HDD 108 to realize the functions of the thin-client server 200.

Similarly, a computer executes a thin-client client program, installed in the HDD or the like in the thin-client client 100, to realize the functions of the client apparatus 10.

Although the image transfer method, the server apparatus, and the program have been described in connection with the embodiments, the present disclosure is not limited to the above-described embodiments, and various modifications and improvements may be made thereto within the scope of the present disclosure. The first to third embodiments may also be combined with each other within a range in which no contraction occurs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling an information processing apparatus, the method comprising:
generating, using a hardware, first image data corresponding to a first area of an image to be displayed on a screen of a client apparatus coupled to the information processing apparatus;
generating, using a processor other than the hardware, second image data corresponding to a second area of the image; and
transferring the first image data and second image data to the client apparatus separately.

2. The method according to claim 1, wherein
the transferring includes:
transferring third image data obtained by excluding, from the first image data, image data of an overlap area in which the first area is overlapped with the second area, and
transferring fourth image data obtained by combining image data of the first image data corresponding to a transparent area with image data of the second image data corresponding to the transparent area, the transparent area being an area in which one of the first image data and the second image data is transparently seen through another one of the first image data and second image data.

3. The method according to claim 1, wherein
the transferring obtains the first image data generated in the generating synchronously with transferring the first image data.

4. The method according to claim 1, wherein
the transferring obtains the first image data asynchronously with generation of the first image data.

5. An information processing apparatus comprising:
a processor configured to
generate, using a hardware, first image data corresponding to a first area of an image to be displayed on a screen of a client apparatus coupled to the information processing apparatus;
generate, using the processor, second image data corresponding to a second area of the image; and
transfer the first image data and second image data to the client apparatus separately.

6. The information processing apparatus according to claim 5,
the processor is configured to
transfer third image data obtained by excluding, from the first image data, image data of an overlap area in which the first area is overlapped with the second area, and
transfer fourth image data obtained by combining image data of the first image data corresponding to a transparent area with image data of the second image data corresponding to the transparent area, the transparent area being an area in which one of the first image data and the second image data is transparently seen through another one of the first image data and second image data.

7. The information processing apparatus according to claim 5, wherein
the processor is configured to obtain the first image data synchronously with transferring the first image data.

8. The information processing apparatus according to claim 5,
the processor is configured to obtain the first image data asynchronously with generation of the first image data.

9. A medium storing a program for causing an information processing apparatus to execute a procedure comprising:
generating, using a hardware, first image data corresponding to a first area of an image to be displayed on a screen of a client apparatus coupled to the information processing apparatus;
generating, using a processor other than the hardware, second image data corresponding to a second area of the image; and
transferring the first image data and second image data to the client apparatus separately.

10. The medium according to claim 9, wherein
the transferring including
transferring third image data obtained by excluding, from the first image data, image data of an overlap area in which the first area is overlapped with the second area, and
transferring fourth image data obtained by combining image data of the first image data corresponding to a transparent area with image data of the second image data corresponding to the transparent area, the transparent area being an area in which one of the first image data and the second image data is transparently seen through another one of the first image data and second image data.

11. The medium according to claim 9, wherein
the transferring obtains the first image data asynchronously with generation of the first image data.

12. The medium according to claim 9, wherein
the transferring obtains the first image data generated in the generating synchronously with transferring the first image data.
